(19) United States
(12) Patent Application Publication
(10) Pub. No.: US 2022/0297067 A1
(43) Pub. Date: Sep. 22, 2022

(54) SYSTEMS AND METHODS FOR CYCLIC AERATION AND MIXING

(71) Applicant: ENVIROMIX, INC, Charleston, SC (US)

(72) Inventors: Sarah O. Elger, Cudahy, WI (US); Tyler J. Kunz, Cedarburg, WI (US); William W. King, JR., Mount Pleasant, SC (US); Theodore K. Jenkins, Daniel Island, SC (US); David D. Lauer, Germantown, WI (US)

(21) Appl. No.: 17/206,993

(22) Filed: Mar. 19, 2021

(51) Int. Cl. B01F 3/04; C02F 1/74; C02F 7/00; B01F 15/00

(52) U.S. Cl. CPC B01F 3/04248; C02F 1/74; C02F 7/00; B01F 15/00344; B01F 2003/04148; B01F 2003/04191; B01F 2003/04872; B01F 2003/04879; B01F 2215/0052; C02F 2103/02

(57) ABSTRACT

Systems and methods for providing aeration and mixing to a substance in a containment unit are disclosed.

### FIELD OF THE INVENTION

The present invention relates to systems and methods for aerating, mixing, or aerating and mixing substances in a containment unit, such wastewater.

### BACKGROUND

Methods and systems for treating wastewater are known in the art. Such methods may include aerating and mixing wastewater during a treatment process.

### SUMMARY OF THE INVENTION

The present invention includes systems and methods as described herein.

In one embodiment, the present invention includes a method for treating a substance. The method includes providing gas to a plurality of diffuser zones in a containment unit and each diffuser zone includes one or more diffusers. The gas is provided exclusively to at least one first diffuser zone for a limited period of time and then subsequently gas is provided in seriatim to one or more additional diffuser zones. In practicing the method, each additional diffuser zone is provided gas for the limited period of time, and gas is provided to less than all diffuser zones at any given time during operation.

In another embodiment, the present invention includes a treatment system. The system includes a containment unit, a source of gas, a plurality of supply headers in connection with the source of gas, and a plurality of diffusers positioned in the containment basis. Each of the diffusers is in connection with a supply header, and the system further includes a flow control device to selectively permit gas to one or more of the diffusers at a particular time. A controller is in communication with the flow control device and is configured to control the flow control device to provide gas to a plurality of diffuser zones in seriatim, such that the gas is provided to less than all diffuser zones at any given time during operation.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

These and other features, aspects, and advantages of the present invention are better understood when the following detailed description is read with reference to the accompanying drawings, wherein:

FIG. 1 is a side cut-away view of a basin with aeration components for use in conjunction with an embodiment of the present invention;

FIG. 2 is a schematic diagram of a controller of a controller box for an exemplary embodiment of the present invention;

FIG. 3 is a side cut-away view of a basin with aeration components for use in conjunction with an alternative embodiment of the present invention;

FIG. 4 is a schematic diagram showing diffuser zones pursuant to an embodiment of the present invention;

FIG. 5 is a schematic diagram showing diffuser zones pursuant to an alternative embodiment of the present invention;

FIG. 6 is a schematic diagram showing diffuser zones pursuant to an embodiment of the present invention;

FIG. 7A is a side cut-away view of a basin with aeration components for use in conjunction with an embodiment of the present invention;

FIG. 7B is a schematic diagram showing diffuser zones pursuant to an embodiment of the present invention;

FIGS. 8A and 8B are a side cut-away views of two basins with aeration components for use in conjunction with an alternative embodiments of the present invention;

FIG. 9 is a schematic diagram showing diffuser zones pursuant to an embodiment of the present invention.

Repeat use of reference characters in the present specification and drawings is intended to represent same or analogous features or elements of the invention.

### DETAILED DESCRIPTION OF EXEMPLARY EMBODIMENTS

Reference will now be made in detail to various embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

Systems and methods of the present invention may be used in connection with various treatments or storage of substances. By way of example, the embodiments of the present invention may be utilized in the treatment of a substance. In other applications, the present may be used in storing substances. One of ordinary skill in the art will appreciate that such uses are for illustrative purposes only and are not intended to limit the full scope of the invention disclosed herein. In addition, certain features of the invention herein may be used in systems disclosed and described in U.S. Pat. Nos. 8,505,881, 8,323,498, and U.S. Published Patent Application No. 2019/0100449, each of which is incorporated herein in its entirety by reference.

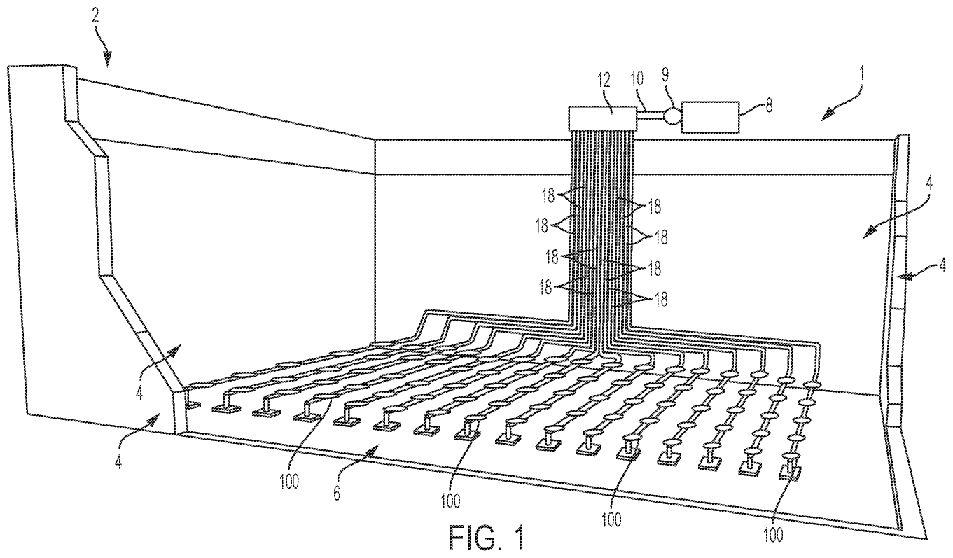

Referring to FIG. 1, a cut-away perspective view of an exemplary wastewater treatment system 1 is shown. The system 1 includes a containment unit for wastewater, which is shown in FIG. 1 as basin 2 having four sidewalls 4 and a bottom 6. The bottom geometry of a containment unit may take any suitable shape, such as, without limitation, flat, sloped, or conical. One of ordinary skill in the art will appreciate that alternative types of containment units, such as tanks, vessels, channels, lagoons, and ditches, are also within the scope of the present invention. A containment unit may additionally have an inlet through which wastewater enters and an outlet through which the wastewater exits. In some embodiments, the containment unit may allow for continuous flow of wastewater whereas other embodiments may restrict the flow of wastewater into and out of the containment unit. In some embodiments, multiple containment units, of the same type or of differing types, may be present and connected such that the wastewater passes through them sequentially or not connected such that wastewater passes thru them in parallel.

With further reference to FIG. 1, a source of gas is shown outside of basin 2 as blower 8, although the placement of blower 8 can be in any suitable location for a particular application, including indoor and outdoor locations. In other embodiments, any suitable source of gas may be utilized, such as a compressor. The source of gas may supply any suitable gas, such as atmospheric air, oxygen, and/or other gases. A source of gas may be utilized to provide gas to a single containment unit or to multiple containment units, including containment units that may are related and/or unrelated in a system. In some embodiments, multiple sources of gas may be utilized. In addition, a source of gas may supply only the containment unit(s) that form part of the system or, in other embodiments, a shared gas source may supply gas to other systems as well. As explained herein, such gas may serve to transfer oxygen to the substance in some embodiments. In the depicted embodiment, blower 8 is connected to supply line 10, which feeds into one or more controller box 12. A conventional regulator 9 or a throttling valve (not shown) may be placed along the supply line to regulate the flow of gas from the blower 8. In other embodiments, any suitable pressure or flow rate control device may be utilized.

In some embodiments, the present invention may be installed in already-existing facilities or in facilities having equipment for other functions. For example, in some embodiments, an existing gas source may be present and gas for the present invention may be supplied by using a slip stream of air from that air source. As described herein, a valve or other flow control device may be used to regulate the gas flow in accordance with embodiments of the present invention.

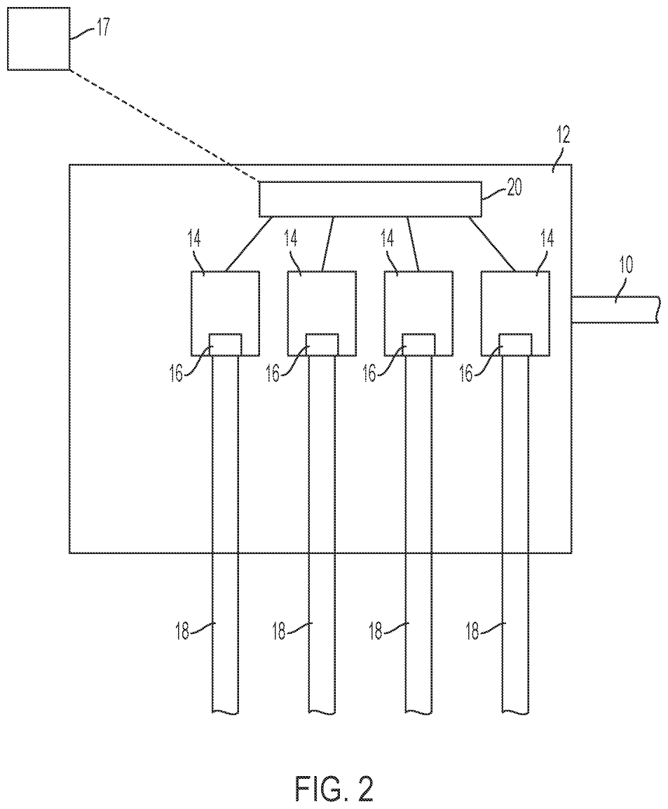

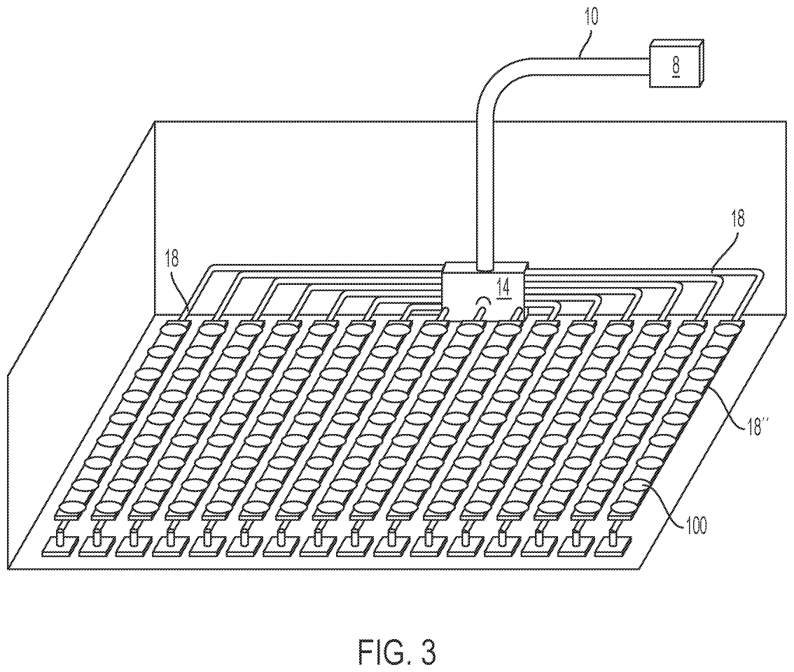

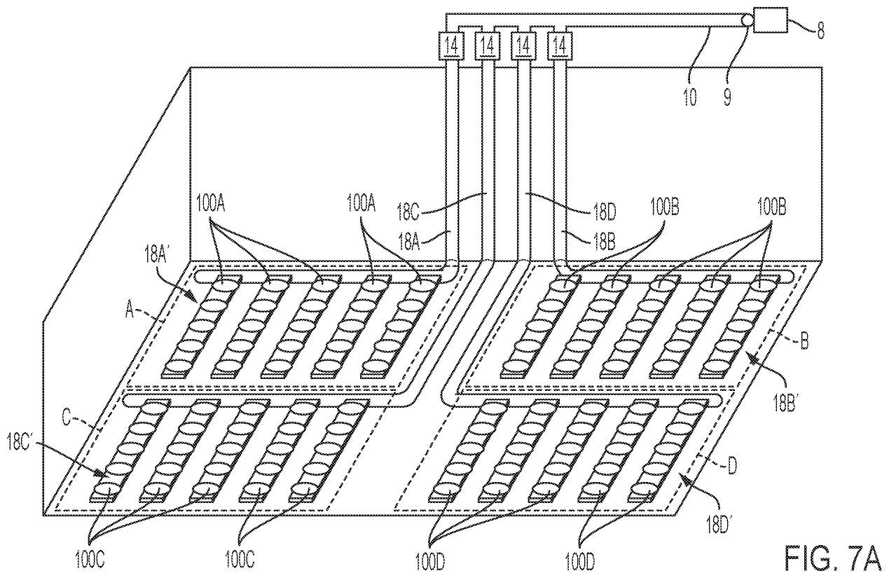

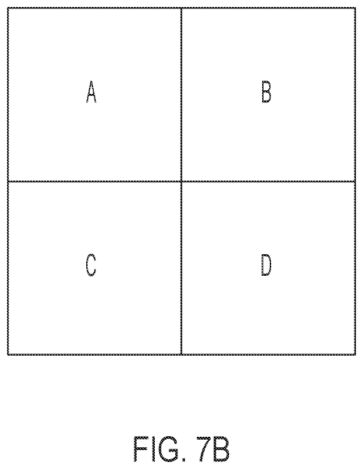

In the depicted embodiment as shown in FIGS. 1 and 2, controller box 12 is located outside of basin 2, but it is understood that the precise placement of controller box 12 may vary or that controller box 12 may be omitted in alternative embodiments. Valves, such as valves 14 having actuators 16, may be positioned between the source of gas, such as blower 8, and the headers 18, such as in controller box 12 as shown in FIG. 2. For example and without limitation, in other embodiments of the invention valves may be placed in alternative positions, such as shown in FIG. 3 in which valves 14 are positioned in basin 2, or outside of a controller box, such as shown in FIG. 7A. Other types of valves or structures to control or direct the flow of gas may be utilized within alternative embodiments of the present invention. For example, individual butterfly or other types of open/close or modulating valves with an actuator, either electro-mechanical or pneumatic, could be employed in some embodiments of the present invention. In still other embodiments, instead of multiple valves, a system may utilize one or more multi-channel valves that are capable of selectively directing gas to one or more particular headers 18. By way of further example, a single multi-port rotating valve may be utilized in some embodiments of the present invention.

The system also may include a controller, such as controller 20, which is shown in controller box 12 in FIG. 2 but may be positioned elsewhere in alternative embodiments. The controller may be any suitable device for controlling the gas flow, such as opening valves, closing valves, and adjusting the degree that a valve is opened. In some embodiments, controller 20 may be a programmable logic controller. As shown in FIG. 2, controller 20 is in communication with valves 14.

In some embodiments, controller 20 may be in communication with a control device 17, such as shown in FIG. 2. Control device 17 may include any machine having processing capacity, such as, by example, a machine having a processor, a memory, and an operating system. In some embodiments, control device 17 may include an interface for inputting such manual instruction. By way of example, and without limitation, control devices may include one or more of a personal computer, handheld computer, microcontroller, PLC, smartphone, and/or tablet. In still other embodiments, control device 17 and/or controller 20 may be any device capable of controlling the operation of a wastewater control system, such as a timer. In such embodiments, a timer or other control device or controller may be adjusted using any suitable means, such as a knob or a dial.

In some embodiments, controller 20 and/or control device 17 may be connected to a wireless and/or wired network. In addition, controller 20 and/or control device 17 may be located within controller box 12, in its proximity, or at a remote location, such as within a treatment facility or at another site. In still other embodiments, a controller and a control device may be a single device. In addition, an existing facility may have existing controllers or control panels or hardware and the present invention could be interfaced with those existing systems, such as by loading software to perform the processes described herein and communicate with the previously-existing structures. Furthermore, as noted, controller 20 and/or control device 17 may be remotely accessible, and it may be configured to a network or internet connection. In addition, control panel 17 and/or controller 20 may permit an operator to manually control the processes and system components, such as manually overriding the automatic control and activating or deactivating aeration to the wastewater.

As used herein, reference to “in communication with” indicates that data and/or signals are transferrable between the referenced components, and such reference includes both physical connections and wireless connections. In addition, “in communication with,” whether used in connection with data or otherwise, also includes embodiments in which the referenced components are in direct connection (i.e., directly connected to each other) as well as indirect connections, such as when data is transmitted through an intermediate component and either relayed in the same format or converted and then relayed to the referenced component. Furthermore, as used herein, the terms “connected” and “attached,” and variations of those terms, includes, unless indicated otherwise by the context, components that are in direct connection and components that are indirectly connected by way of other components.

Systems of the present invention may also include one or more supply headers 18 in which gas passes from the source of gas. Supply headers 18 may be made of any suitable material, such as polyvinyl chloride (PVC), acrylonitrile butadiene styrene (ABS), chlorinated polyvinyl chloride (CPVC), fire retardant polypropylene (FRPP), other plastic, galvanized steel, stainless steel, carbon steel, copper, or any other material from which piping may be formed and which meets the requirements of the particular system. Supply headers 18 can be made of a single, continuous component or, in an alternative embodiment, supply headers 18 can be constructed from multiple components, such as multiple series of pipes, joined by conventional measures, such as welding, adhesive, threading, bending, use of a connector, or other known connection measures or combinations thereof.

As shown in FIGS. 1-2, supply headers 18 may extend, directly or indirectly, between a source of gas, such as blower 8, and one or more diffusers 100 such that gas from the gas source, such as blower 8, may be provided to diffusers 100 to transfer oxygen and aerate the wastewater in basin 2. In other embodiments, such as shown in FIG. 3, a a supply line 10 may be in connection with the source of gas and extend into basin 2, and a valve or valves 14 (such as a gas manifold) may connect that supply line 10 to multiple other headers 18 such that gas may be selectively passed from the single header to one or more of the other headers as described herein. In yet other embodiments, such as shown in FIG. 7A, nozzles 14 may each control the flow of gas to a single header, such as headers 18A, 18B, 18C, or 18D, which may supply gas to a plurality of headers 18′ with each header 18′ having a plurality of diffusers 100. In such an embodiment, as explained below, such diffusers associated with a single header may form a diffuser zone, such as zones, A, B, C, and D shown in FIG. 7A. In still other embodiments, a single header may be connected to all diffusers and a controller and/or control panel may control a valve at each diffuser to selectively supply gas to only certain diffusers as described herein. Other configurations, including additional supply lines or headers, may be used in alternative embodiments of the present invention. Within basin 2, headers 18 may be arranged in any suitable manner and, as explained above, valves may be used to selectively control the flow of gas to any particular diffuser(s).

As shown in the exemplary embodiment shown in FIGS. 1-2, diffusers 100 have a single or plurality of openings to allow for the release of gas into a containment unit. Any suitable type of diffuser may be used in systems and methods of the present invention, including, without limitation, course bubble diffusers and fine bubble diffusers. In alternative embodiments, other types of aeration devices may be utilized, such as jet aeration systems in which pumped fluid is expelled through openings along a header or manifold and can also introduce gas into the fluid stream. Diffusers 100 may be connected, directly or indirectly, with headers and valves and positioned throughout basin 2 in a pattern to create a plurality of cyclic zones based on how gas is supplied to them in operation as explained in more detail below. The particular configuration of headers and diffusers may depend upon the size of a containment unit and the particular process or processes being performed. As such, the arrangements of headers and aeration devices within a particular system may be varied in different embodiments of the present invention.

In some embodiments, to obtain uniform or nearly uniform flow to all nozzles connected to a particular header, the present invention may include orifices, which may be located at any location between a header and a diffuser (or other aeration device). Such orifices may be a relatively smaller passageway that limits flow from the header to the diffuser. In some embodiments, a check valve (not shown) may be used in addition to or instead of an orifice. Such check valves permit flow of gas from the header to the diffuser but do not permit backflow from the tank to the header. By using an orifice or check valve as described herein, the gas in the header may be provided in a generally equalized manner to each diffuser associated with that header. In addition, check valves offer an additional advantage of preventing backflow into the system, which could result in clogs and other problems in the system. The cracking pressure (at which flow is permitted in the output direction) can be selected for any particular system.

In operation, systems of the present invention may function to aerate and/or mix the contents of a containment unit. For example, with reference to the embodiment shown in FIG. 1, blower 8 provides gas to diffusers 100 through headers 18, and the pressure or flow of the gas may be regulated by a flow control device, such as valves 14 described above. Controller 20 and/or control panel 17 may activate and deactivate the flow of gas to selective diffuser heads 100, thereby controlling the aeration of the contents of basin 2. For example, valves 14 may be capable of opening and closing to selectively and controllably allow the gas to flow to any particular diffusers 100 or any particular group of diffusers 100, such as, in FIG. 1, the five diffusers positioned on a single header or, as shown in FIG. 7A, a group of diffusers in connection with a common valve such as one of the groups of diffusers 100A, 100B, 100C, or 100D. In some embodiments, controller 20 and/or control panel 17 may also control the rate of gas flow to diffusers 100.

In some embodiments of the present invention, no more than one valve 14 is open at any given time such that only a single diffuser 100 is providing gas to basin 100 at any given time during operation. In alternative embodiments, a plurality of valves 14 may be simultaneously open. In still other embodiments, any number of diffusers less than the total number of diffusers in they system may be provided with gas at any given time. The gas provided to basin 2 from diffusers 100 may serve to aerate, mix, or both aerate and mix the solution in basin 2. In particular, the gas may serve to aerate the content of a containment unit, such as wastewater.

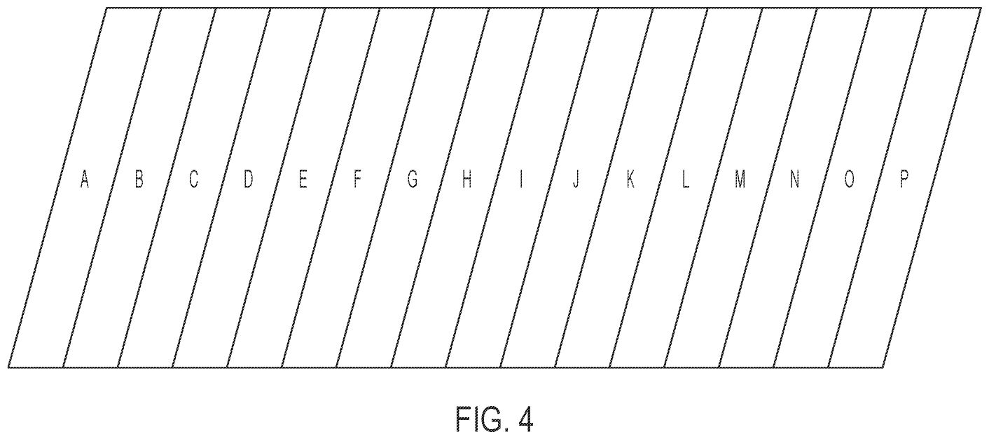

In some embodiments, systems of the present invention may be operated in cyclical manner. In particular, gas may be provided to diffusers in a cyclic, sequential manner. For example, with reference to FIG. 1, in some embodiments gas may be provided to a single diffuser 100 or any group of diffusers 100 for a predetermined time followed by providing gas for a predetermined time to each other diffuser 100 or any group of diffusers 100 sequentially. With such operation, each diffuser 100 defines a diffuser zone, and 16 diffuser zones A-P result as schematically shown in FIG. 4. By way of example, gas may be provided sequentially to diffusers 100A-P in sequential order and, after a cycle through each zone is completed, the cycle may be repeated. In alternative embodiments, the sequence of providing gas to the zones may be modified in any suitable order. In some embodiments, each zone must be provided with gas only once before the cycle is ended and repeated.

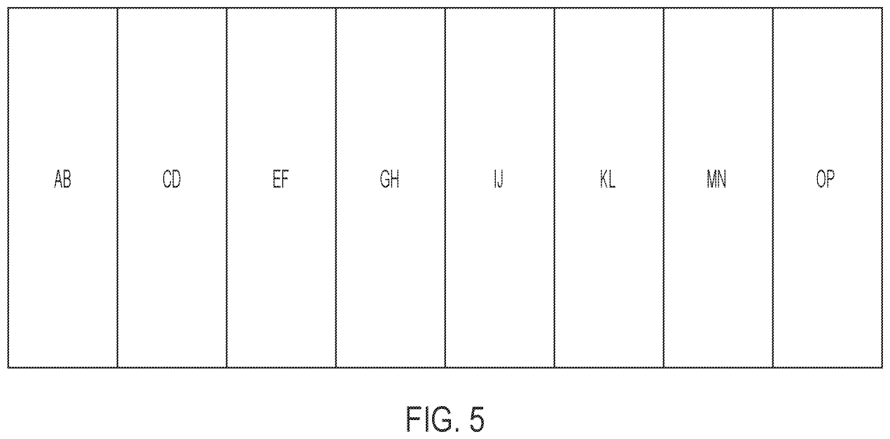

In an alternative embodiment, a set of diffusers may be simultaneously provided with gas. In this manner, multiple diffusers may collectively define a diffuser zone. For example, as shown in FIG. 5, two diffusers may be provided with gas simultaneously, such as diffusers 100A and 100B, for a predetermined time, thereby collectively forming diffuser zone AB. Subsequently, gas may be provided simultaneously only to diffusers 100C and 100D for a predetermined time, thereby collectively forming diffuser zone CD. In similar fashion, gas may be provided sequentially to diffuser zones EF, GH, IJ, KL, MN, and OP. After a cycle through each zone, the cycle may be repeated.

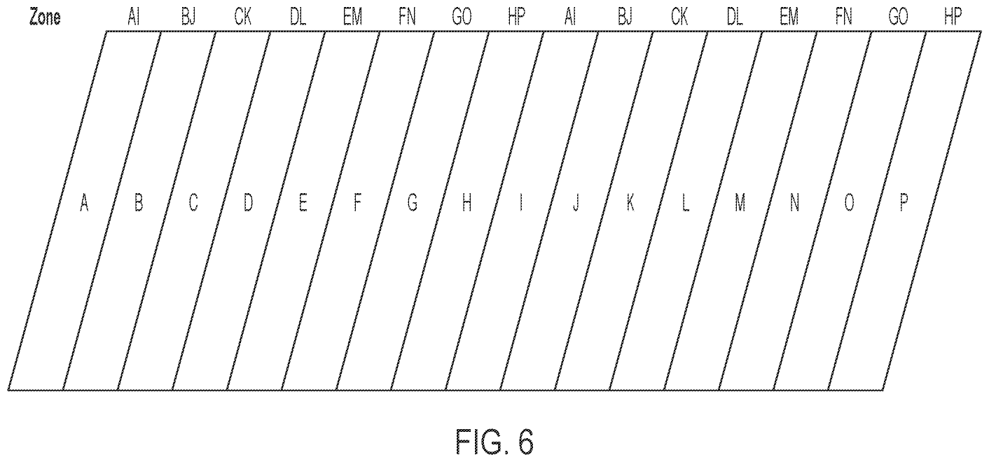

In still other embodiments, non-adjacent diffusers 100 may be provided with gas simultaneously to collectively form a diffuser zone. For example, with reference to FIG. 6, diffusers 100A and 100I may be provided with gas simultaneously for a predetermined time to form diffuser zone 100A, followed by diffusers 100B and 100J being provided with gas simultaneously for a predetermined time thereby collectively forming diffuser zone BJ, followed by diffusers 100C and 100K being provided with gas simultaneously for a predetermined time thereby collectively forming diffuser zone CK, and so forth as shown in FIG. 6. After a cycle through each zone, the cycle may be repeated.

The aforementioned examples are by way of illustration and other cyclic zone treatments are within the scope of the invention. In some embodiments, alternative sequencing of zones may be used. By way of example, with reference to FIG. 6, alternative sequences such as AI-DL-GO-BJ-EM-CK-FN-HP or any other alternative sequences may be used. In still other embodiments, three or more diffusers may be simultaneously provided with gas to collectively form a diffuser zone. For example, and without limitation, the embodiment in FIG. 6 may alternatively provide gas to zones AI and HP (totaling four diffusers) simultaneously to effectively form diffuser zone AI-HP and, similarly, other zones may be combined such that a sequential treatment process such as AI-HP, BJ-GO, CK-FN, DL-EM. Similarly, alternative combination of zones and sequences may be utilized in other embodiments of the present invention. In some embodiments, gas is not provided to all zones at any given time and, instead, gas is only provided to less than all zones at any given time. In still other embodiments, gas may be provided continually such that, during operation, at least one zone is receiving gas at all times of operation.

In traditional processes, gas may be provided simultaneously to the entirety of a containment unit. In such instances, the gas flow rate per unit of containment unit volume may be in a range such as between 5-100 standard cubic feet per minute per 1000 cubic feet of containment unit for aeration or mixing. By contrast, in some embodiments of the present invention, gas may be supplied to less than the entirety of a containment unit at any given time, such as to one or more zones at a time. In such embodiments, a localized proportional gas flow rate per unit of tank volume is delivered to a zone in the cycle that is consistent with standards for gas delivery for treatment, aeration, or mixing. In other words, a proportional amount may be delivered to a particular zone using the present invention instead of providing gas flow simultaneously to the entirety of the containment unit. Such embodiments may also provide adequate aeration and mixing for each zone and for the entirety of the containment unit at all times as explained herein.

FIG. 7A depicts an alternative embodiment of a wastewater treatment system of the present invention. As shown in that embodiment, certain headers 18 supply gas to certain diffusers, wherein the diffusers that are connected to the same header are arranged in proximity to each other to create diffuser zones. Specifically, header 18A, which may also be called a manifold, is connected to five headers 18A′ with each header having five diffusers. As such, header 18A is connected to twenty-five diffusers 100A to form diffuser zone A. Similarly, header 18B is connected to twenty-five diffusers 100B to form diffuser zone B, header 18C is connected to twenty-five diffusers 100C to form diffuser zone C, and header 18D is connected to twenty-five diffusers 100D to form diffuser zone D (wherein the diffuser zones are shown schematically in FIG. 7B). In this embodiment, if gas is supplied to a single header 18 at any given time in the manner described above, then gas is provided to the respective diffuser zone associated with that header. In the same manner described above, gas may be provided to one or more zones at a given time, and a cycle of supplying gas to the zones may be utilized and repeated.

For example, with continued reference to FIGS. 7A and 7B, gas may be sequentially supplied to zones in the order of A, B, C, and D in some embodiments. In such an embodiment, gas may be supplied as follows: (1) gas is supplied exclusively to zone A for a certain interval for a certain period of time, (2) gas to zone A is halted and gas is supplied to zone B exclusively for a certain period of time, (3) gas to zone B is halted and gas is supplied to zone C exclusively for a certain period of time, (4) gas to zone C is halted and gas is supplied to zone D exclusively for a certain period of time, and (5) the cycle is repeated. In some embodiments, the period of time for each zone is equal for each zone and, in other embodiments, the period of time for gas supply to each zone may vary for each respective zone.

In still other embodiments, the provision of gas to a zone may not be exclusive. For example, with continued reference to the example described above for FIG. 7A, the provision of gas in cycling between zones may be overlapped over multiple zones. In such an embodiment, gas may be supplied as follows: (1) gas is supplied exclusively to zone A for a certain interval for a certain period of time, (2) gas is continued to zone A while gas is also supplied to zone B for a certain period of time, (3) gas is halted to zone A and gas is supplied exclusively to zone B gas for a certain period of time, (5) gas is continued to zone B and gas is also supplied to zone C for a certain period of time, (6) gas is halted to zone B and gas is supplied exclusively to zone C for a certain period of time, (7) gas is continued to zone C while gas is also supplied to zone D for a certain period of time, (8) gas is halted to zone C and gas is supplied exclusively to zone D gas for a certain period of time, (9) gas is continued to zone D while gas is also supplied to zone A for a certain period of time, (10) gas is halted to zone D and gas is supplied exclusively to zone A gas for a certain period of time, and (11) the cycle is repeated. In still other embodiments, gas may be simultaneously provided to multiple zones at the same time in other manners.

In other embodiments of operating the system in FIG. 7A, multiple diffuser zones may be provided with gas at a particular time. For example, gas may be supplied only to zones A and C simultaneously for a certain period of time followed by supplying gas simultaneously to only zones B and D, after which the cycle may be repeated. Alternative zones and sequences are likewise within the scope of the present invention. In some embodiments, gas is not provided to all zones at any given time and, instead, gas is only provided to less than all zones at any given time. In still other embodiments, gas may be provided continually such that, during operation, at least one zone is receiving gas at all times of operation. In addition, in yet other embodiments a treatment process or cycle may include one or more periods in which gas may not be supplied to any zones.

By way of further example, a cycling method may be described with continued reference to FIG. 7A. For purposes of illustration only, the containment unit of FIG. 7A may require 4,000 standard cubic feet per minute (scfm) of gas to be supplied to meet conventional mixing and process gas requirements. However, by using certain embodiments of the present invention, the total gas flow required to meet the demands for process gas and mixing may less than 4,000 scfm due to the cyclic provision of gas to zones as described herein. By way of example, in some embodiments, the requisite gas flow for the exemplary embodiment may only be in the range of 1,000-2,000 scfm, including each intermittent range and value therein. The reduction in gas flow requirements is permitted because the gas is being “cycled” between the four zones. The specific calculation of the reduced gas flow rate may be based on the number of zones per containment device and the gas required for the specific process and/or the mixing requirements for the specific zone in the containment device. In some embodiments, the gas flow reduction from conventional processes could be directly proportional to the number of zones in the system. In still other embodiments, the gas flow rate may be non-proportional to the conventional gas flow. And, in still other embodiments, gas flow rates may differ between zones.

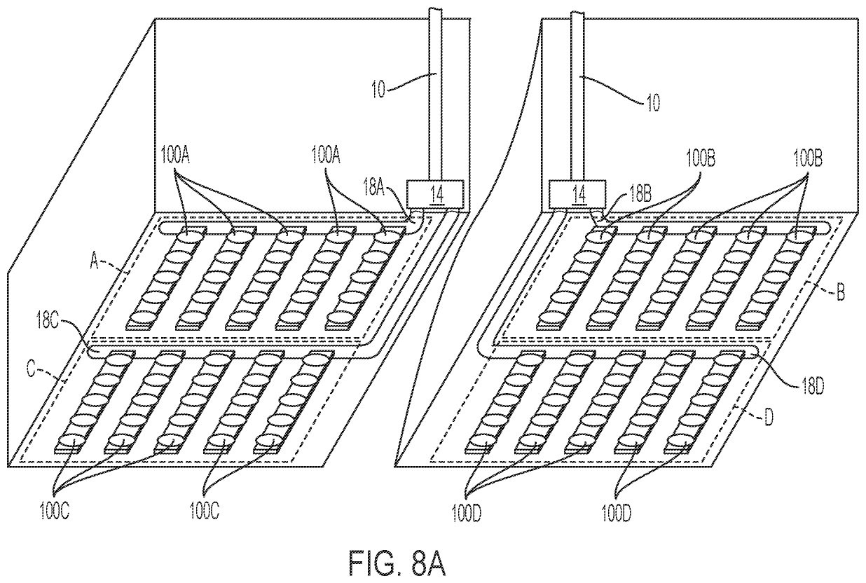

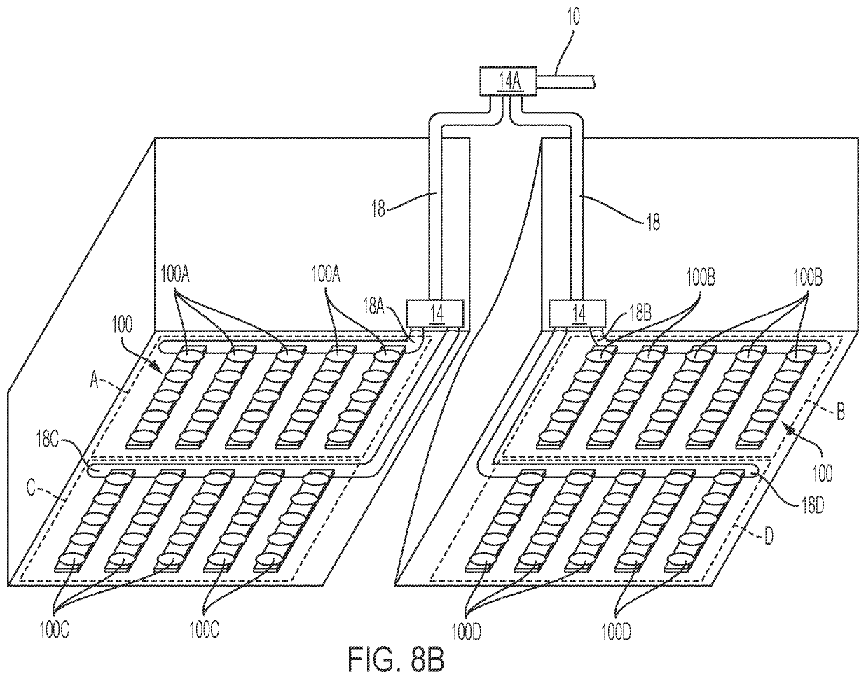

FIG. 8 illustrates an alternative embodiment of the present invention that includes multiple containment units. In some embodiments, a cyclic process of the present invention may include zones that are cycled in both containment units. In other words, the zones dispersed throughout both containment units may be included in a cyclical treatment process of the present invention. As shown in FIG. 8A, zones A and C are in one containment unit and zones B and D are in a different containment unit. Valves 14 (which may also be referenced as a valve manifold) may control the flow of gas to the zones in each containment unit. Although present in distinct containment units, a cycle may include in seriatim treatment of the zones of both containment units. In other embodiments, such as shown in FIG. 8B, an additional valve 14A (or valve manifold) may further control the flow of gas to a header 18 leading into each containment unit. In either the exemplary embodiments of FIG. 8A or 8B, a common controller and/or control panel may control the flow of gas to specific headers of all containment units.

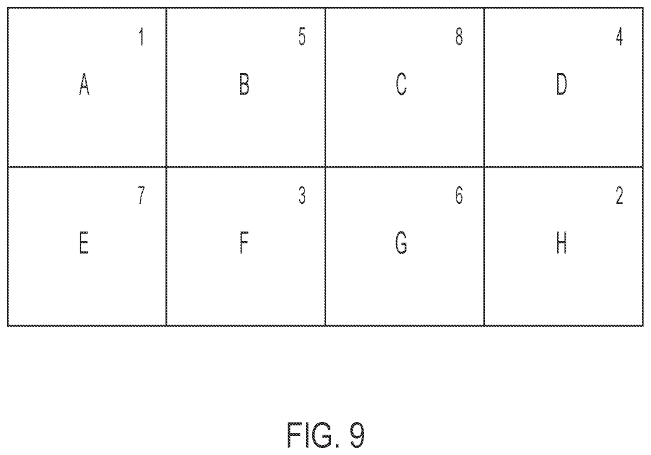

In some embodiments of the present invention, a cycle may include alternating providing gas to proximate and distant zones. For example, FIG. 9 illustrates a system that includes diffuser zones A-H, which may be formed by using the structures described above. By way of example and without limitation, gas may be sequentially supplied to a single zone at a time in the sequential order of zones A, H, F, D, B, G, E, and then C. By alternating the sequence of zones provided with gas based on proximity, any aeration or mixing effects that may extend beyond a zone provided with gas and into one or more adjacent zones is utilized to assist in maintaining the aeration and/or mixing of zones while they are awaiting their next turn in the cycle.

In still other embodiments of cycling the provision of gas to a zone, multiple zones may be provided with gas at a particular time in a sequence to spread the gas throughout the containment unit during a cycle, such as to spread the aeration and/or mixing effects in some embodiments. For example, with reference again to FIG. 9, gas may be provided simultaneously to zones AH for a certain period of time, followed by gas being provided simultaneously to zones CF for a certain period of time, followed by gas being provided simultaneously to zones DE for a certain period of time, and followed by gas being provided simultaneously to zones BG for a certain period of time. In another embodiment, gas may be provided simultaneously to zones AH for a certain period of time, followed by gas being provided simultaneously to zones BG for a certain period of time, followed by gas being provided simultaneously to zones CF for a certain period of time, and followed by gas being provided simultaneously to zones DE for a certain period of time. The foregoing examples are not limiting and other cyclic sequences may be utilized in other embodiments of the present invention. In still other embodiments, any plurality of zones that is less than the total number of zones may be aerated simultaneously. For example, two zones, three zones, four zones, or any other plurality of zones may be provided with gas simultaneously as part of a cycling sequence so long as not all zones of the system are not provided with gas at one time and that there is some cycling sequence of various zones.

As a result of using a gas source, such as a blower, to provide gas to the zones in a cyclic manner as described herein, the gas source may remain continuously operating during operation of the system, wherein the gas supplied is diverted, such as by valves, to appropriate zones based on the cycle sequence. In some embodiments, however, the gas source may be halted or powered off for periods of time, either on a regular or cyclic basis or as needed or warranted for a particular system. In some embodiments of the present invention, no additional mixing equipment, such as mechanical mixers, are present in the containment unit being aerated, such as basin 2, and any requisite mixing is accomplished by the operation of the diffusers 100.

Regardless of the particular number of zones or cycling pattern, in some embodiments each supply of gas to a particular zone during a cycle provides ample gas to aerate and/or mix the substance, such as wastewater, in that zone. In addition, in some embodiments, the supply of gas provided to a zone is sufficient to retain sufficient aeration or mixing of that zone until it is provided with gas again in a cyclic operation. In such embodiments, the entire substance may be maintained in a sufficiently aerated and/or mixed state throughout the entire treatment process. In still other embodiments, the provision of gas in a cycle may not retain sufficient or complete mixing of the substance throughout a zone or the entire basin or throughout the entire treatment process. In some cyclic operation embodiments, gas may be provided based on a predetermined amount of time per zone, wherein such a predetermined amount of time per zone may depend on the requirements of a particular system. For example, in some embodiments, the predetermined time may be based on the amount of gas necessary to accomplish suitable aeration and/or mixing for the contents of a particular diffuser zone. With respect to the sequence cycle for the diffuser zones, a cycle may be designed such that no zone reaches an insufficient level of aeration or mixing. Such sequencing and timing parameters for a particular system may be calibrated upon installation or at any time by testing cycle time parameters and measuring the aeration level (such as by measuring dissolved oxygen content and/or oxidation-reduction potential (ORP)) and the sufficiency of mixing (such as by measuring the total suspended solids). In some embodiments, a cycle may be determined by measuring the maximum time period that providing gas may be ceased to a particular zone (while other zones are aerated) before the aeration or mixing becomes unsuitable, and the frequency of providing gas to that zone may be set to a value at or below that maximum time period. In some embodiments, the system may maintain the substance (including in all zones) in a sufficiently aerated and/or mixed state at all times.

Given that the contents of a mixing system may vary based on influent levels and other factors, some embodiments of the present invention may allow for dynamic or proportional mixing and aeration controls. For example, desired parameters for a system, such as the amount, duration, and/or frequency of gas supplied to a zone under certain conditions may be calibrated, such as by adjusting valve operations, during the installation process for a particular volume in the containment unit. As the volume varies, it may be desirable in some applications to maintain a consistent impact on the system. Thus, the parameters, including the amount, duration, and frequency of gas supplied to each zone may be adjusted proportionately (as dictated by the controller and/or control panel) based upon a measured or calculated volume, flowrate, process parameter (such as COD or NH4), and/or based other measured or calculated parameters of the substance in the containment unit, so that the impact on the system remains proportionately consistent during dynamically-changing operating conditions. Thus, as the substance level and/or substance parameters increase or decrease, the system may modify the mixing duration, frequency, and/or intensity in a manner that it proportionally remains at that desired operational settings. Methods of measuring and determining such volume or substance parameters of the treatment substance are disclosed in U.S. Pat. Nos. 8,505,881, 8,323,498, and U.S. Published Patent Application No. 2019/0100449, each of which is incorporated herein in its entirety by reference. Appropriate data for such operations can be stored in a memory in or connected to the control panel or may be determined by using the processor in the control panel. Any adjustments to the cycle parameters may be completed by adjusting which valves are opened, the duration of their opening, and/or the sequencing of their opening to allow air to flow to particular diffusers.

Although the foregoing description has been provided in the context of wastewater aeration and mixing, other types of wastewater treatment and other applications unrelated to wastewater are within the scope the present invention. By way of example, embodiments of the present invention could include aeration and/or mixing processes or other treatment processes in oxidation ditches, sludge treatment, water storage, chemical storage, sequencing batch reactors, pumping stations, drinking water, clean water, and food and beverage processing tanks. As such, the foregoing description of illustrative embodiments of the invention has been presented only for the purpose of illustration and description and is not intended to be exhaustive or to limit the invention to the precise forms disclosed. Numerous modifications and adaptations thereof will be apparent to those of ordinary skill in the art without departing from the scope of the present invention.

We claim:

1. A method for treating a substance comprising:
providing gas to a plurality of diffuser zones in a containment unit, wherein each diffuser zone comprises one or more diffusers,
wherein gas is provided exclusively to at least one first diffuser zone for a limited period of time and then subsequently gas is provided in seriatim to one or more additional diffuser zones, wherein each additional diffuser zone is provided gas for the limited period of time,
wherein gas is provided to less than all diffuser zones at any given time during operation.

2. The method of claim 1 wherein the gas is provided to the diffuser zones in a sequential order in a cycle wherein each diffuser zone is provided with gas at least once in the cycle.

3. The method of claim 2 wherein gas is provided to one diffuser zone at any given time and each diffuser zone is provided with gas during one time period in each cycle.

4. The method of claim 2 wherein each diffuser zone comprises multiple diffusers.

5. The method of claim 1 wherein gas is provided to the plurality of diffuser zones in a sequence, wherein the sequence comprises not providing gas to adjacent diffuser zones in the containment unit sequentially.

6. The method of claim 1 wherein the gas is provided to transfer oxygen to the substance in the containment unit.

7. The method of claim 1 wherein the gas provided to a zone is sufficient to aerate the substance in that zone.

8. The method of claim 1 wherein the gas provided to a zone is sufficient to mix the substance in that zone.

9. The method of claim 1 wherein the gas provided to a zone is sufficient to aerate and mix the substance in that zone

10. The method of claim 1 wherein the method is repeated.

11. The method of claim 8 wherein the gas provided to a zone is sufficient to aerate the substance in that zone and to maintain an adequate aeration level until gas is introduced to that zone again when the method is repeated.

12. The method of claim 1 wherein the substance in the containment unit remains aerated during the method.

13. The method of claim 1 wherein the substance in the containment unit remains mixed during the method.

14. The method of claim 1 wherein the substance in the containment unit remains aerated and mixed during the method.

15. The method of claim 1 wherein the substance is wastewater.

16. The method of claim 1 wherein the substance is selected from the group consisting of drinking water and clean water.

17. A treatment system comprising:
a containment unit,
a source of gas,
a plurality of supply headers in connection with the source of gas,
a plurality of diffusers positioned in the containment basis, wherein each of the diffusers is in connection with a supply header, and
a flow control device to selectively permit gas to one or more of the diffusers at a particular time,
a controller in communication with the flow control device, wherein the controller is configured to control the flow control device to provide gas to a plurality of diffuser zones in seriatim, wherein the gas is provided to less than all diffuser zones at any given time during operation.

18. The treatment system of claim 13 wherein each diffuser zone consists of one diffuser.

19. The treatment system of claim 13 wherein each diffuser zone comprises multiple diffusers.

20. The treatment system of claim 13 wherein the system is configured to provide gas to a single diffuser zone at any point in time during operation.

21. The treatment system of claim 13 wherein the system is configured to provide gas to a plurality of diffuser zones at any point in time during operation.

22. The treatment system of claim 13 wherein the system is configured to provide sufficient gas to aerate a substance in the zone receiving the gas.

23. The treatment system of claim 13 wherein the system is configured to provide sufficient gas to mix a substance in the zone receiving the gas.

24. The treatment system of 13 wherein the system is configured to maintain sufficient aeration and mixing of a substance in the containment unit during a treatment process.
